(19) United States
(12) Patent Application Publication
(10) Pub. No.: US 2015/0007795 A1
(43) Pub. Date: Jan. 8, 2015

(54) ANTI-POLLUTION ECONOMISER DEVICE

(71) Applicant: DUKIC DAY DREAM S.r.l., DUEVILLE (Vicenza) (IT)

(72) Inventor: Michele Campostrini, Schiavon (IT)

(73) Assignee: DUKIC DAY DREAM S.r.l., DUEVILLE (Vicenza) (IT)

(21) Appl. No.: 14/368,818

(22) PCT Filed: Dec. 17, 2012
(86) PCT No.: PCT/IB2012/057390

§ 371 Date: Jun. 26, 2014

(30) Foreign Application Priority Data
Dec. 28, 2011 (IT) BO2011A000763

(51) Int. Cl. F02M 27/04

(52) U.S. Cl. CPC F02M 27/04
USPC 123/445

(57) ABSTRACT

This invention relates to an anti-pollution economiser device for hydrocarbons of the type comprising a conduit which may be coupled along the fuel supply pipe and comprising an electromagnetic field generator which affects the fuel flowing inside the conduit from its inlet to its outlet and comprising at least one aeration channel inside the device and in free communication with the outside environment for cooling the conduit subject to the effects of the electromagnetic field.

### Technical field

This invention relates to an anti-pollution economiser device for hydrocarbons, in particular diesel, hereafter referred to with the term fuel, of the type comprising a conduit which may be coupled along the fuel supply pipe and comprising an electromagnetic field generator which affects the fuel flowing inside the conduit from its inlet to its outlet.

### BACKGROUND ART

Anti-pollution devices which use magnetic or electromagnetic fields are already known in the prior art, such as, for example, those indicated in the introduction of European patent EP 1 408 227 B1.

European patent EP 1 408 227 B1 protects an anti-pollution device characterised by a particular type of conduit which creates a sort of undulating labyrinth-like path for the fuel which is repeatedly diverted relative to the longitudinal axis of the conduit of the device, and through which the fuel is made to pass. The inlet and outlet of the conduit are connected on the fuel supply line to an engine upstream of its injection pump.

The device enters into operation with the start-up of the engine and the molecular pulverisation of the fuel with energy charging of its free radicals obtained from the electromagnetic field generated inside it optimises and improves the combustion of the fuel and, therefore, the general efficiency of the engine, with a considerable reduction in the unburnt carbon particles which remain inside the engine.

The above-mentioned effect optimises the fuel combustion and either prevents the production of pollutants by the engine or results in the production of extremely small quantities compared with failure to use the above-mentioned device, which is marketed and identified by the trademark DAP, an acronym of Dispositivo Anti Particolato, or Anti-Pollution Device.

Experiments and tests on the device covered under patent EP 1 408 227 B1, applied to uses with diesel engines and hydrocarbon engines in general and also for applications with civil and industrial boilers, have shown a reduction in the following pollutants:
CO (carbon monoxide) up to −90%;
CO2 (carbon dioxide) up to −25%;
HC (unburnt hydrocarbons) up to −85%;
NOx (nitric oxides) up to −20%;
NO2 (nitrogen dioxide) up to −35%;
PM10 (particulate matter) up to −50%.

It has also been observed and found that a significant increase is obtained in the torque and output of the engine at low engine revolutions, with values of up to +30%; a reduction in the fuel consumption is also achieved which can vary from 4.5% to 10% depending on the type of use of the vehicle and/or of the civil and industrial boilers on which the DAP device is applied.

It has been found by experimentation that the electromagnetic field generator of prior art devices—such as the device of European patent EP 1 408 227, which generate an electromagnetic field in the same direction as the fuel flow, and which comprise solenoids powered with continuous current, with a substantially cylindrical extension, insulated electrically from the conduit in which the fuel flows by means of insulated sleeves wrapped around the conduit coaxially with the axis of the conduit—can generate a heat which could give rise to negative effects downstream of the devices due to the variation of the volume of the fuel inside the devices. This variation in volume is due to the variation in temperature which the fuel undergoes when passing inside the conduit of the device inserted in the line for supply of fuel to the internal combustion engine.

### AIM OF THE INVENTION

The aim of this invention is to overcome the above-mentioned drawback by means of a solution providing a chamber between the conduit in which the fuel flows and the electromagnetic field generator which is in open communication with the outside environment so as to have a ventilation inside the chamber preventing the transmission of heat between the electromagnetic field generator and the conduit of the device in which the fuel flows, and contributing towards dissipating any increase in heat of the fuel due to the effects of the magnetic field.

Further aims and advantages, which will become more apparent in the description which follows, are achieved, according to the invention, by the device according to the invention, structured and designed as described in the accompanying claims.

### BRIEF DESCRIPTION OF THE DRAWINGS

The invention is described in more detail below with reference to the accompanying drawings, which illustrate a preferred, non-limiting embodiment and in which:

FIG. 1 schematically shows where the device according to this invention is inserted in a fuel supply line of an internal combustion engine;

FIG. 2 shows a side view of the device according to this invention;

FIG. 3 shows a longitudinal cross-section of the device according to this invention.

### DETAILED DESCRIPTION OF PREFERRED EMBODIMENTS OF THE INVENTION

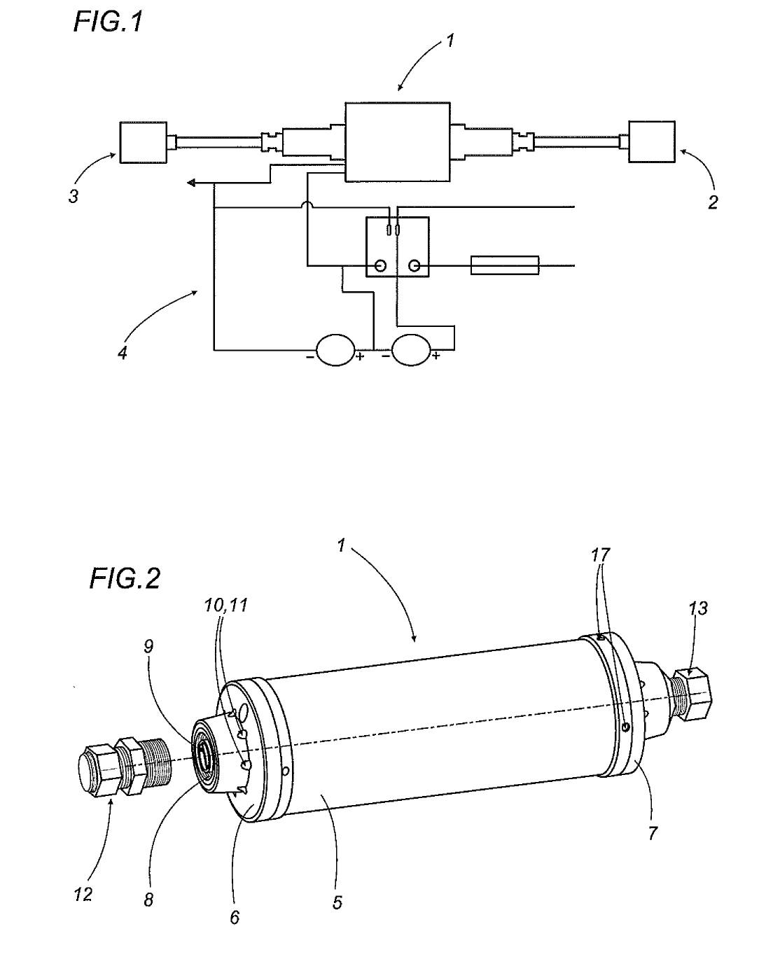

With reference to FIG. 1, the numeral 1 denotes the device according to this invention located on the fuel (diesel) supply line between a tank 2 and the injection pump 3 of a diesel engine of a vehicle not illustrated in the drawings. The device 1 is provided with an operation and control electrical circuit 4 which is directly connectable to the power supply battery of the vehicle.

With reference to FIG. 2, the device 1 comprises a hollow cylindrical body 5 closed at its ends by two flanges or heads 6 and 7 with an axial hole 8 for the passage of the ends of a conduit 9 which, as described below, is connectable to the line for supply of the diesel from the tank 2 to the injection pump 3.

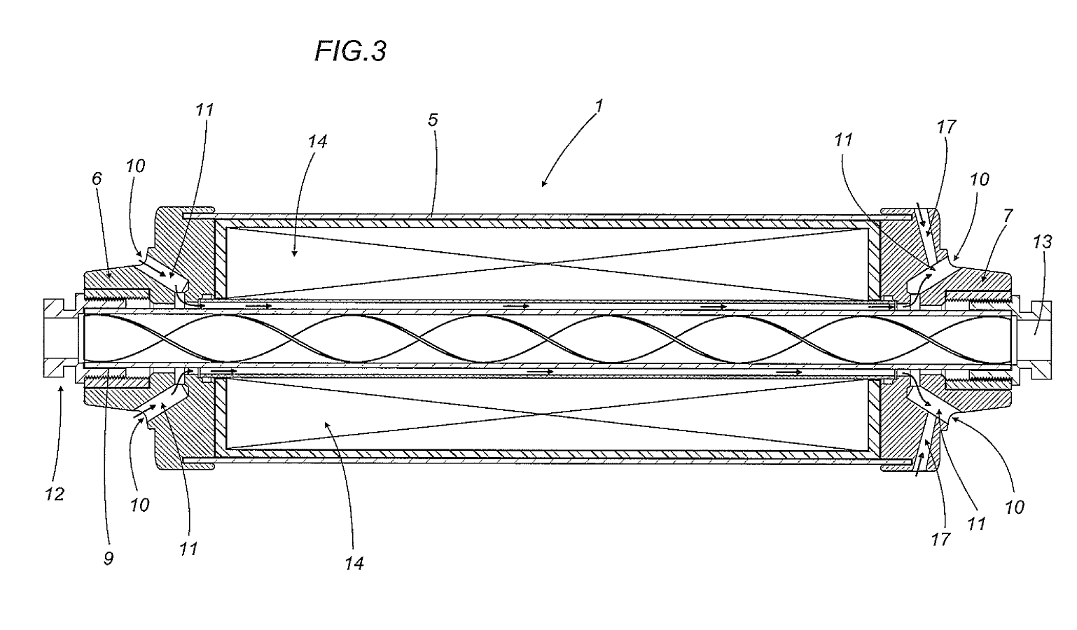

The heads 6 and 7 have a first series of holes 10 on the periphery which define the opening towards the outside of as many ducts 11 (see FIG. 3), as described below, with a truncated cone shape on the head 6 and a cylindrical shape on the head 7.

With reference to FIG. 3, the device 1 comprises the above-mentioned conduit 9 equipped with inlet 12 and outlet 13 means which may be coupled directly in a sealed manner along the fuel supply line.

The numeral 14 denotes an electromagnetic field generator designed to affect the fuel flowing inside the conduit 9 with an electromagnetic field in the same direction as the fuel flow, using solenoids powered with continuous current, with a substantially cylindrical extension and insulated electrically from the hollow cylindrical body 5. The electromagnetic field generator 14 is connected using the electrical circuit 4 (FIG. 1) to the power supply battery of the vehicle on which the device is installed.

The conduit 9 is provided on the inside with a sort of undulating labyrinth-like path for the fuel which is repeatedly diverted relative to the longitudinal axis of the conduit 9.

According to this invention, the conduit 9 is positioned inside a channel or jacket 15 connected, in a sealed manner, to the heads 6 and 7. The internal diameter of the channel or jacket 15 is relatively larger than the outer diameter of the conduit 9 and which defines, around the latter, a gap or chamber 16 in in open communication with the outside environment using the ducts 11 presented by the heads. This provides a ventilation chamber between the electromagnetic field generator 14 and the conduit 9 by means of which dissipation of the heat is obtained which could otherwise be transmitted from the electromagnetic field generator 14 to the conduit 9 in which the fuel flows and passes to the injection pump 3, thereby allowing the fuel temperature to be kept constant along the entire supply line from the tank 2 to the injection pump 3.

To facilitate the circulation of the air inside the chamber 16 at least one of the heads 6 and 7, preferably the head 7 which is positioned at the means 13 for outflow of the fuel from the device 1, is provided with further cone-shaped ducts 17—see FIG. 3—in communication with all or part of the first ducts 11 present on this head, so as to generate a Venturi effect which favours the outflow of the air from the inside of the ventilation chamber 16.

The device according to this invention can be normally used, as described, along the line for supply of a liquid fuel for operating vehicle engines, but it can be also used for any other liquid fuel derived from hydrocarbons used for the supply of internal combustion engines or burners not for vehicles, such as in the case of boilers.

It shall be understood that the invention described above may be modified and adapted without departing from the scope of the inventive concept. Moreover, all the details of the invention may be substituted by other technically equivalent elements.

1. An anti-pollution economiser device for fluid fuels, of the type comprising a conduit which may be coupled along the fuel supply pipe to form an integral part of the supply line and comprising an electromagnetic field generator which affects the fuel flowing inside the conduit from its inlet to its outlet, characterised in that it comprises at least one channel forming an aeration chamber in open communication with the outside environment and made or positioned between the electromagnetic field generator and the conduit in which the fluid flows, the channel extending between the inlet and the outlet of the conduit so as to form a gap between the conduit and the electromagnetic field generator of the device.

2. The anti-pollution economiser device, according to claim 1, characterised in that at the inlet and outlet of the conduit there are flanges or heads and for closing the body of the device, each of which is fitted with at least one duct in direct contact with the outside and with the channel forming the chamber which thereby adopts the function of aeration gap between the conduit and the electromagnetic field generator of the device.

3. The anti-pollution economiser device, according to claim 1, characterised in that it comprises:
a hollow cylindrical body closed at its ends by a flange or head and having a central/axial hole for the transit of the inlet and outlet ends, respectively, of a conduit positioned coaxially to the hollow cylindrical body, for the inflow and outflow of the fluid fuel into and out of the device, the ends of the conduit being fixed to the heads and by means of devices and designed to allow their fixing to the fuel supply line from a tank to an internal combustion engine, so as to form an integral part of the line;
an electromagnetic field generator consisting of solenoids with a substantially cylindrical extension, positioned inside the hollow cylindrical body and insulated from it, enveloping the conduit coaxially to the hollow cylindrical body, the solenoids powered with continuous current and being able to produce an electromagnetic field in the same direction as the fuel flow;
a channel positioned between the conduit and the solenoids constituting the electromagnetic field generator, with an inside diameter greater than the outside diameter of the conduit and the ends of which are fixed to the flanges or heads and for closing the hollow cylindrical body of the device, the channel having an inside diameter such as to create a gap between the conduit and the electromagnetic field generator;
the heads and for closing the hollow cylindrical body of the device being equipped with at least a first duct open towards the outside and in direct communication with the gap between the conduit and the electromagnetic field generator;
the inside of the conduit being made in such a way as to create a sort of undulating labyrinth-like path for the fuel which is repeatedly diverted relative to the longitudinal axis of the conduit of the device.

4. The anti-pollution economiser device, according to claim 3, characterised in that each of the heads and for closing the hollow cylindrical body of the device comprise a series of first ducts open towards the outside and in direct communication with the gap between the conduit and the electromagnetic field generator, the ducts being uniformly distributed on the heads.

5. The anti-pollution economiser device, according to claim 3, characterised in that at least the head for closing the hollow cylindrical body located at the means for outflow of the fuel from the conduit which may be inserted in the supply line to an internal combustion engine or to a burner, has at least one second series of holes with a truncated cone shape which form as many ducts open towards the outside and in communication with at least a part of the first series of ducts for communicating with the outside of the gap or ventilation chamber interposed between the conduit and the electromagnetic field generator, the first and second series of holes in communication with each other being made and positioned in such a way as to generate a Venturi effect for favouring the outflow of the air from the aforementioned ventilation chamber.
